(19) United States
(12) Patent Application Publication
(10) Pub. No.: US 2005/0014902 A1
(43) Pub. Date: Jan. 20, 2005

(54) Methods of recycling and/or upgrading olefin (co)polymers

(76) Inventors: William James McMahon, Elsternwick Victoria (AU); Hans Anton Mayer, Beaumaris (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/485,175

(22) PCT Filed: Jul. 31, 2002
(86) PCT No.: PCT/AU02/01021

(30) Foreign Application Priority Data
Jul. 31, 2001 (AU) PR 6729

(51) Int. Cl. C08F 2/00

(52) U.S. Cl. 525/242

(57) ABSTRACT

The present invention relates to a method of recycling and/or upgrading an olefin (co)polymer, olefin (co)polymer scrap and/or mixtures thereof including adding effective amounts of a vinyl silane and a free radical initiator to graft the vinyl silane to the olefin (co)polymer. The present invention also relates to olefin (co)polymers, olefin (co)polymer scrap and/or mixtures thereof whenever recycled and/or upgraded by the method defined above and articles which are composed wholly or partly of them.

The present invention relates to methods of recycling and/or upgrading olefin (co)polymers, especially olefin (co)polymer scrap. The methods have particular application to polyethylene or its scrap, more specifically high density polyethylene (HDPE) used in milk bottles.

Considerable amounts of milk bottle scrap are recovered, but there have been insufficient economically useful applications developed to use the recovered product. The use of milk bottle scrap as a raw material to manufacture articles of higher added value such as bottles, containers for motor oils or chemicals, pipes and tubes is currently not possible.

Milk bottles are composed of high density polyethylene (HDPE), of grades which are designed for one processing step only. The recycling of milk bottle material has either not been possible or has caused considerable problems. Such problems include stress cracking, too many pinholes and non-uniform wall thickness, together with the negative public opinion associated with the use of recycled materials in food applications.

The environmental stress crack resistance (ESCR) of milk bottle material and its scrap as defined in ASTM No. D1693B, is very low. As a consequence, the ESCR of the recovered material is unacceptable in most applications.

Attempts have been made to use recovered milk bottle scrap in applications such as pipes, films and mobile garbage bins. However, the proportion of scrap that could be incorporated without serious deterioration in properties was uneconomically low. The low ESCR was particularly problematic.

A requirement accordingly exists for methods of recycling and/or upgrading (co)polymer scrap, in particular milk bottle scrap so that it can be used in higher value-added applications.

According to the present invention there is provided a method of recycling and/or upgrading an olefin (co)polymer, olefin (co)polymer scrap and/or mixtures thereof including adding effective amounts of a vinyl silane and a free radical initiator to graft the vinyl silane to the olefin (co)polymer.

Further according to the present invention there is provided a method of upgrading an olefin (co)polymer, olefin (co)polymer scrap and/or mixtures thereof which fails the ESCR test as defined in ASTM No. D1693B including adding effective amounts of a vinyl silane and a free radical initiator to graft the vinyl silane to the olefin (co)polymer.

The present invention also provides an olefin (co)polymer, olefin (co)polymer scrap and/or mixtures thereof whenever recycled and/or upgraded by the methods defined above.

The present invention further provides articles which are composed wholly or partly of the olefin (co)polymer, olefin (co)polymer scrap and/or mixtures thereof whenever recycled and/or upgraded by the methods defined above.

The term “scrap” is used herein in its broadest sense and refers to discarded or waste (co)polymers which need to be recycled, reprocessed and/or upgraded. It is preferable to use the method of the present invention for recycling and/or upgrading (co)polymer scrap for reasons of economy and cost.

Suitable olefin (co)polymers and their scrap include ethylene (co)polymers such as polyethylene, ethylene-propylene copolymers, ethylene-propylene-diene terpolymers (EPDM), ethylene vinyl acetate copolymers (EVA), copolymers of ethylene-alkyl acrylates, for example ethylene-ethyl acrylate (EEA) and ethylene-butyl acrylate (EBA) and their terpolymers with maleic anhydride or mixtures thereof. The preferred olefin (co)polymer is polyethylene of all grades and types including high-density polyethylene (HDPE), medium density polyethylene (MDPE), low density polyethylene (LDPE), very low density polyethylene (VLDPE), ultra low density polyethylene (ULDPE) and linear low density polyethylene (LLDPE). It will be appreciated that the above olefin (co)polymers are also available as metallocene catalyst (co)polymers. Preferably the (co)polymers have a specific gravity (S.G.) of above about 0.936. HDPE or its scrap is particularly preferred as this is the polymer from which many plastic bottles, in particular milk bottles are manufactured. More preferably, the HDPE has a S.G above about 0.942, even more preferably above about 0.945 and most preferably about 0.95 to about 0.96.

While both homopolymers and copolymers can be used in the method of the present invention, preferably homopolymers are used. It will be appreciated that the homopolymer may contain up to about 5% by weight of comonomer.

In a particularly preferred embodiment, the (co)polymer is (co)polymer scrap or mixtures of (co)polymer scrap and (co)polymer.

Prior to the grafting step, the (co)polymer is preferably collected, sorted, washed, granulated, pelletised and/or filtered. The (co)polymer or part thereof may also be grinded and/or milled into powder form and used as such or a portion of it mixed with granules.

The (co)polymer which may be in the form of granules, pellets, powder and/or dices can then be pre-dried for example in warm air, hot air or desiccated air to low residual moisture levels, preferably less than about 500 ppm, more preferably less than about 200 ppm. The (co)polymer may then be mixed in any suitable known apparatus, such as, for example, a continuous mixer or extruder, internal mixer, discontinuous mixer such as Banbury type mixers or batch mixers. Continuous mixers or extruders are preferred. Combined mixers with a first part having two mixing cylinders similar to those of an internal mixer and a second part having an extruder of the single or twin screw type, for example, the Farrel-Pomini type can also be used. Most preferred are twin screw, co-rotating extruders or mixers or compounding machines.

The continuous mixer may be either a twin-screw mixer with counter rotating or preferably co-rotating screws which have mixing sections on them, for example, a ZSK mixer from Werner and Pfleiderer, a twin screw mixer from Reifenhauser or a Buss-ko-kneader or single screw extruder with sufficient mixing ability in the barrel or cylinder of the extruder.

The (co)polymers and/or additives can be added or fed into different ports of the mixing apparatus, for example, in the first third, second third or final third of the length of the co-extruder or twin-screw mixer.

The length of the mixing apparatus for mixing, melting and grafting can be from about 7:1 (length:diameter) to about 40:1, preferably about 10:1 to about 36:1, most preferably about 22:1 to about 36:1 depending on the type of mixing apparatus, types of materials used, productivity and costs. A higher ratio from 22:1 to 40:1 is preferred as there is a higher residence time for the mixing, melting and grafting which, assuming the same residence or reaction time for the grafting, means a higher output. The grafting time and thereby the output is also dependent on the type of (co)polymer(s) to be grafted and the type of vinyl silane and initiator mix, in particular the half life time or decomposition time of the initiator at the grafting temperature.

The vinyl silane may be a vinyl alkoxy silane such as vinyl-tris-methoxy-silane (VTMOS), vinyl-tris-methoxy-ethoxy-silane, vinyl-tris-ethoxy-silane, vinyl-methyl-dimethoxy-silane and gama-methacryl-oxypropyl-tris-methoxy-silane.

The term “free radical initiator” is used herein in its broadest sense and refers to an unstable molecule or compound which generates free radicals. More specifically, the free radicals are generated when the initiator is heated to temperatures of above the melting point of the (co)polymer(s), their scrap and the initiator or in general to melt at processing temperature. Examples of suitable initiators include peroxides such as dicumyl peroxide (DCP, Dicup), di-tertiary-butyl peroxide (DTBP), di-tertiary-butylcumyl peroxide (DTBCP), di(tert-butylperoxy-isopropyl)benzene (Luperox F), 2,5-dimethyl-2,5-di(tert.butylperoxy)hexane (Luperox 101), and other known dialkylperoxides and diarylperoxides. The free radical initiator is preferably added in an amount of about 0.05% to about 0.3% by weight of the (co)polymer, more preferably about 0.08% to about 0.2% by weight, most preferably about 0.10% to about 0.16% by weight. It will be understood that, by having a defined ratio of initiator to vinyl silane, for example about 1:10 to about 1:15 which will depend on the type of vinyl silane, the type of initiator and their active components or molecular weights, the amount of initiator will vary in correlation with the amount of vinyl silane added.

The vinyl silane is preferably mixed with the free radical initiator and this mix may be added in an amount from about 0.5 to about 2.4% by weight of the (co)polymer, preferably about 0.8 to about 2% by weight, more preferably about 0.9 to about 1.6%, even more preferably 0.9% to 1.4%, most preferably about 1% to 1.2%.

Alternatively, the vinyl silane and initiator mix can be incorporated, adsorbed to and/or absorbed into a carrier, such as, for example, other polyolefins advantageously in the form of granules or particles and added to the (co)polymer for grafting.

The vinyl silane may also be added separately to the free radical initiator and in this case the above amounts will be reduced by the amount of initiator contained in the mix, such as about 0.1 to about 0.2% by weight of the (co)polymer, usually about 0.1% to about 0.15%.

The vinyl silane and the initiator can also be added separately, in a pre-mixing step, to the polyolefin (co)polymer and/or scrap. Preferably some powder is added, more preferably HDPE powder is added in an amount of about 5 to about 10% or more of the (co)polymer mix, to which the initiator and the silane is then added and the mix is then fed into the mixing apparatus whereby the whole of the (co)polymer and scrap can be a powder.

It will be understood that the amount of vinyl silane added together with the initiator or the amount of silane per se will depend on the type of (co)polymer being recycled and/or upgraded, the type of the vinyl silane, the type of initiator added and on the desired degree of cross-linking or of other related properties such as ESCR or resistance to chemicals.

Preferably, the grafting step is performed at a melt temperature of from about 180° C. to about 230° C., more preferably about 190° C. to about 220° C., most preferably about 200° C. to about 220° C. Alternatively, a melt may be formed of the (co)polymer prior to adding the vinyl silane and initiator in the (co)polymer or (co)polymer melt for grafting.

In another embodiment, one or more additives and/or fillers known in the art of polymer processing can be added either before, during or after grafting of the vinyl silane. It will be appreciated that such additives and/or fillers can also be included in the pre-mixture of the silane and initiator.

Suitable additives include antioxidants, processing and/or thermal stabilisers, for example, tris (2,4-ditert-butylphenyl) phosphite (phosphite based), pentaerythritol tetrakis (3-(3,5-di-tertbutyl-4-hydroxyphenyl)propionate), octadecyl-3(3,5-di-tert-butyl-4-hydroxyphenyl)propionate, 3,3′,3′,5,5′,5′-hexa-tert-butyl-a,a′,a′-(mesitylene-2,4,6-triyl)tri-p-cresol (phenolic based) and dioctadecyl-3,3′-thiodipropionate (thioester based); metal deactivators and/or copper inhibitors, for example, oxalyl-bis(benzylidenehydrazide and 2,3-bis((3-(3,5-di-tert-butyl-4-hydroxyphenyl)propionyl))propionohydrazide; UV stabilisers, for example, poly((6-((1,1,3,3-tetramethylbutyl)amino)-1,3,5-triazine-2,4-diyl)((2,2,6,6-tetramethyl-4-piperidinyl)imino)-1,6-hexanediyl((2,2,6,6-tetramethyl-4-piperidinyl)imino))),bis(2,2,6,6-tetramethyl-4-piperidyl)sebaceate and phenol-2-(5-chloro-2H-benzotriazole-2-yl)-6-(1,1-dimethylethyl)-4-methyl; blowing agents which may be either endothermic or exothermic for example, p.p-oxybis benzene-sulfonyl-hydrazide, azo-iso-butyro-nitrile and azodicarbonamide; catalysts, for example, cross-linking catalysts such as dibutyltindilaurate and dioctyltindilaurate; and pigments, for example, inorganic pigments such as titanium dioxide and carbon black and organic pigments. The pigments can also be added as a colour masterbatch or concentrate.

Suitable fillers include mineral fillers such as calcium carbonate, magnesium calcium carbonate, hydrated basic magnesium carbonate, talc, clays which may be calcined, kaolin, aluminium hydroxide (aluminium trihydrate) and magnesium hydroxide. The fillers may be optionally coated with, for example, stearates such as calcium stearate, magnesium stearate or stearic acid or silanes such as vinyl silanes. Some of these fillers have flame retardant properties, as do some of the (co)polymers defined herein. However, if desired other flame retardants may be added such as halogenated flame retardants based on brominated and/or chlorinated materials; phosphate based compounds, for example, ammonium polyphosphate; and esters of phosphoric acid. The fillers preferably have a low moisture/humidity level of less than about 1000 ppm, more preferably less than about 500 ppm, most preferably less than about 200 ppm.

The non-halogenated flame retardants may be added in one step if sufficiently dry or preferably in a separate step after the grafting of the vinyl silane onto the (co)polymer so as to avoid interference with or influence on the grafting of the vinyl silane by the initiator. In the presence of acidic by-products such as hydrochloric or hydrobromic acid from the halogenated compounds generated at higher processing temperatures, the initiator decomposition which is normally a radical decomposition process needs to initiate the grafting of the silane, may be changed from a radical mechanism and diverted to an ionic mechanism with ionic side products which reduce the grafting of the silane onto the (co)polymer.

The type, combination and amount of additives and/or fillers may be chosen according to the intended final application. Additives generally are added up to about 10% and fillers up to about 50% by weight based on the amount and type of (co)polymer and/or scrap being recycled and/or upgraded.

Either before, during or after the grafting step, other (co)polymers or their scrap can be added to enhance the properties of the recycled and/or upgraded (co)polymer. Examples of such (co)polymers include polyolefins such as ethylene vinyl acetate copolymer (EVA), ethylene ethyl acrylate copolymer (EEA), ethylene butyl acrylate copolymer (EBA), ethylene propylene rubber (EPR), ethylene-propylene copolymer (EPM), ethylene propylene-diene terpolymer (EPDM), ethylene-butylene copolymer (EBM), ethylene butylene-diene terpolymer (EBDM), very low density polyethylene (VLDPE), ultra low density polyethylene (ULDPE) linear low density polyethylene (LLDPE), low density polyethylene (LDPE) and medium density polyethylene (MDPE). Examples of (co)polymers which can be added after the grafting step possibly in another processing step include polypropylene, nitrile butadiene rubber, chlorinated polyethylene and chloro-sulfonated polyethylene. The other (co)polymers may be added in amounts of from about 5% to 95% of the recycled and/or upgraded (co)polymer, preferably about 5% to about 50%. The other (co)polymers may be used in their original form or be upgraded, recycled and/or grafted with silanes. The amount of other (co)polymers added will depend on whether the intention is to modify the grafted (co)polymer or to use the grafted (co)polymer to modify other polymers.

The final recycled and/or upgraded polymer is preferably melted, mixed and then filtered and/or screened, for example, using a filter or screen pack in order to remove any contamination or foreign matter particles either during or as a separate step to the method of the invention. The final (co)polymer can optionally then be pelletised either by die-face cutting or by extruding strands which are cooled, for example, in a water bath and then cut into granules. Tapes may also be formed or extruded with the more elastic compounds which are then diced later, for example, using a Condux dicer or pelletiser. The granules or pellets may then be dried by known methods, such as, in warm air and preferably desiccated air, to a level of preferably less than about 500 ppm, more preferably less than about 200 ppm packed into suitable vessels such as bags, boxes or containers, preferably with a metallic layer or a metallic film to avoid diffusion or penetration of water vapour.

The recycled and/or upgraded (co)polymer of the invention can be formed by any suitable known process including injection moulding, blow moulding, compression moulding, extrusion calendering or other known conversion processes into articles such as bottles, containers, boxes, tubes, pipes, cables, profiles, sheets, films and pre-forms.

Suitable catalysts for cross-linking include di-butyl tin dilaurate (DBTDL), di-octyl tin dilaurate (DOTDL) or other known catalysts which are used for crosslinking or curing the compounds at temperatures from ambient to elevated temperatures up to about 115° C. in the presence of water, steam, moisture or humid air.

When a cross-linking catalyst is used in a one step process, it is added to the (co)polymer preferably as a mix with the vinyl silane and initiator either before or during the grafting step or just after the grafting step, but in the same apparatus or process step, the recycled and/or upgraded (co)polymer is formed after leaving the apparatus into the desired article.

In a two step process, the catalyst is added in the second step which comprises mixing and melting the grafted (co)polymers and the catalyst masterbatch and the subsequent forming process which is conducted in a suitable forming apparatus, such as, for example, an extruder, injection or blow moulding machine or calender.

In another variation, no catalyst is added in the two steps of grafting and forming and the grafted and formed material cross-links naturally in the presence of humidity or without a catalyst but over a longer time period. Alternatively, the catalyst may be added as a solution or dispersion in water into the (warm or hot) water bath in which the formed products may be cross-linked or cured.

Alternatively, the final (co)polymer or articles manufactured therefrom may be cross-linked in the presence of water, water vapour or steam at temperatures from about ambient up to about 115° C., preferably about 70° C. to about 100° C., at ambient pressure more preferably from about 80° C. to about 95° C. at ambient pressure. Preferred ranges for cross-linkable HDPE are from about ambient to about 115° C., preferably about 90° C. to about 100° C. and for cross-linkable LLDPE are from about ambient to about 105° C., preferably about 90° C. to about 100° C. Cross-linking times range from about 2 hours to about 60 hours or more dependent on the temperature and the thickness of the product or several days to weeks at ambient temperature.

The degree of cross-linking can be tested using any suitable known technique such as the solvent extraction test or gel test, where the insoluble, cross-linked fraction in new materials has to achieve a minimum, which is preferably about 50% in new materials but which may be higher or lower for recycled and/or scrap materials, depending on the article and type of (co)polymer recycled and/or upgraded and the ultimate use. The degree of cross-linking can also be tested by using the hot set test as described by Australian Standard AS-1660 and equivalent International standards: IEC, BS, VDE/DIN, where dumbbells of the material with weights attached are placed in a hot air oven at 200° C. and the elongation is measured after 15 minutes with the weights attached and later with the weights removed.

For some applications, the degree of cross-linking can be tested using the hot-set test at 150° C. in an air oven. The quoted minimum in the gel test and/or maximum elongation in the hot set test are applicable to the grafted (co)polymer recycled and/or upgraded mainly based on polyethylene such as HDPE. Different results will be obtained when other (co)polymers, additives and/or fillers are added.

The recycled and/or upgraded (co)polymer can also be used to improve properties of other polymeric material, for example, about 5% to about 95% of grafted cross linkable polyethylene can be added to improve the ESCR and/or thermo-mechanic properties of other materials. Preferably the recycled and/or upgraded (co)polymer may be added in proportions of above about 30%, preferably above about 50%.

Conversely it is preferable to use more than about 50% of the recycled and/or upgraded (co)polymer, more preferably above about 70%, even more preferably above about 85%, most preferably above about 90% or up to 100% of the polymer for economical reasons.

The invention will now be described with reference to the following examples. These examples are not to be construed as limiting the invention in any way.

In the examples, a mixture of vinyl tris-methoxysilane (VTMOS) and peroxide, (trade name “SILOX” VS911) was used to graft the HDPE bottle scrap, original HDPE, EVA and/or a metallocene polyolefin (Affinity EG8200) in the form of granules or pellets with some powder added for processing. The bottle scrap used was either used as such dry or pre-dried for 24 hours with hot dehumidified air in a dehumidifier. In examples 1 to 7, 9 and 12 to 18, the SILOX and the HDPE bottle scrap was added just after the hopper of the co-extruder into a port of the co-extruder. In examples 8, 10 and 11 the SILOX, part of the HDPE bottle scrap and HDPE powder were mixed together in a high speed mixer at 150 rpm for 1 minute and then at 300-350 rpm for another minute. This mix was then added to the HDPE prior to the mixing/grafting.

The method of examples 8, 10 and 11 is preferred. We found that the grafting reaction was better, the silane was grafted more completely and no odour of unreacted silane was felt on the outcoming hot granules, whereas when the SILOX was added into the melt there was some odour detected.

The examples were run on a co-rotating twin screw extruder, Werner & pfleiderer ZSK type, L:D ratio 36:1 (36D), 53 mm screw diameter. Examples were (also) run on a Toshiba TEM 120 mm co-rotating twin screw extruder continuous mixer, L:D ratio 36:1, screw diameter 120 mm.

The screw rotations per minute (rpm's) were in the available range up to 300 rpm, preferably 200 rpm. The cylinder temperatures were in the limits of between 180-240° C., preferably around 200-220° C. The melt temperatures were between the limits of 180-240° C., but generally between 200-220° C. depending of which material(s) (co)polymer(s) were used for grafting.

After mixing and grafting in the twin screw extruder, strands with a round cross-section were extruded, cooled in a water bath, granulated, dried and packed.

For longer storage, samples were packed in either plastic bags or bags with laminated aluminium foil or in plastic or glass bottles.

The samples were then kept for later reference and cross-checking of the melt flow index (MFI) (which in some cases tends to reduce in time). In some cases, a processing aid masterbatch containing about 5% fluorocarbon polymer was added in an amount of 1%.

The samples of grafted, cross-linkable granules were then further processed usually by adding DOTDL catalyst masterbatch (made in house from DOTDL and HDPE) in a proportion of 5:95 to the main grafted (co)polymer and/or scrap i.e. about 1:20 or about 5%, were then further processed in a laboratory extruder making tapes and/or an injection moulding machine for making plaques from which dumbells were cut and or in a film blowing extrusion.

The samples cut from the tapes or dumbells were made by injection moulding and then cross-linked at temperatures between ambient, RT (room temperature) however for testing of crosslinking they were mainly crosslinked in steam at between 90 and 100° C., at atmospheric pressure, or to further accelerate the process of preparation and testing, at up to 115° C. in a pressure cooker.

The times used in the laboratory were 30 minutes, 1 hour, 2 hours or 4 hours. 30 minutes and 1 hour were used to expedite testing obtaining good cross-linking, however 4 hours was used later to obtain an optimal cross-linking. In fact examples 6, 9, 10 and 11 were cross-linked for 4 hours at 115° C., with 1.2% Silox added and showed excellent cross-linking, e.g. HST hot set test results at 200° C. under load had very excellent elongations of only around 16% and/or up to around 33%. The AS and International Standards allow up to 175% elongation under load. A good quality silane cross-linking is from 60% up to around 100% or 120%. Excellent cross-linking is when the HST is about 10 to 60% elongation. Without the load the elongation was around 0%, the standard allows max. 15%. This shows potential to further reduce the amount of silane, as seen later. Different results apply when elastomer is added to the main polyethylene or scrap.

Further tests were carried out as follows:
mechanical properties (tensile strength (TS) and elongation at break (EB)),
oil resistance (OR) test (ASTM oil number 2, as in ASTM, AS 1660) 4 hours at 70° C. (as for plasticised PVC, e.g. for cables, which has a moderate resistance to oil), 18 hours at 100° C. and 18 hours at 120° C. (as for oil resistant rubbers). (LDPE or regular XLPE based on LDPE are not known to be oil resistant). The retention in % of mechanical properties after oil immersion, indicates the oil resistance. This depends of the type of oil or solvent, chemical used.
ESCR=Environmental Stress Crack Resistance (ASTM 1693B) The test was carried out to ASTM on dumbells at 50° C. in a solution of detergent in water. This test shows resistance to detergents, surfactants, soaps and is an indication of resistance to stress crack in the environment & in chemicals, etc. Injection moulded dumbells, (unnotched dumbells) were used. The ESCR improved considerably, from not resistant i.e. a few hours to 48 hours (requested by some standards for cables) to 1000 hours and more. Some samples reached up to 5000 hours and are continuing into 7000 hours, depending on criteria such as time to failure of 20% of the samples (F20), or F50 (time to failure of 50% of the samples). F0 means that there are no failures.

Except where shown otherwise in the examples antioxidant IRGANOX 1330 and metal deactivator Naugard XL-1 (Uniroyal) were added separately to stabilise the HDPE, in a masterbatch together with the DOTDL catalyst which was added to accelerate crosslinking, after grafting during the preparation of test samples by extrusion and/or moulding.

The masterbatch was composed of Irganox 1330 4.5%, Naugard XL-11.5%, Catalyst Metatin 812ES 0.4% in HDPE GM5010 (powder) 93.6% compounded and granulated. 5% of this masterbatch was added to 95% of the HDPE.

In other examples the antioxidant and metal deactivators are shown. In these examples, the same amount of DOTDL catalyst was added in the same proportions as a masterbatch separately, prior to the extrusion or moulding of the samples, to accelerate cross-linking.

In regular use, part of the antioxidants, and particularly process stabilisers e.g. Irgafos 168 process stabilisers are added at the compounding and grafting stage and another part are added together with i.e. in the catalyst masterbatch.

Cross-linking of the samples was in hot water and/or steam (water vapour). The amounts quoted in the examples are in weight part per 100 parts of base (co)polymer to be recycled and/or upgraded.

The quantities are shown in phr (parts per hundred parts weight of HDPE, bottle grade).

In some cases where materials from previous examples are used and mixed with other materials, % by weight are shown. “HDPE bottle scrap” refers to “milk bottle scrap” in the examples.

ESCR is conducted at 50° C. in a solution of 10% detergent in water. F0 means no failure, F10 means one failure of 10 dumbells, F20 is Failure of 2 dumbells and F50 is failure of 5 dumbells out of 10.

### EXAMPLE 1

| | |
|---|---|
| HDPE, bottle scrap granulated | 100 |
| Vinyl silane and peroxide mix (Silox VS911) | 1 phr |
| Antioxidant and catalyst MB (masterbatch) | 5 phr |
| (added later, prior to forming and cross-linking) | |
| Hot Set Test (HST) 200° C., under load, (HST): | 70% |

### EXAMPLE 2

| | |
|---|---|
| HDPE, bottle scrap granulated | 100 |
| Vinyl silane and peroxide mix (Silox VS911) | 1.2 phr |
| Antioxidant and catalyst MB (added later) | 5 phr |
| HST | 50% |

### EXAMPLE 3

| | |
|---|---|
| HDPE, bottle scrap, granulated and pre-dried | 100 |
| Vinyl silane and peroxide mix (Silox VS911) | 1 phr |
| Antioxidant and catalyst MB (added later) | 5 phr |
| HST | 40% |

### EXAMPLE 4

| | |
|---|---|
| HDPE, bottle scrap granulated and pre-dried | 100 |
| Vinyl silane and peroxide mix (Silox VS911) | 1.2 phr |
| Antioxidant and catalyst MB (added later) | 5 phr |
| HST | 43% |
| ESCR F0 (stopped test at) | 3800 hrs+ |
| Tensile Strength (TS) | 24.3 Mpa |
| Elongation at Break (EB) | 226% |
| Oil Resistance (ASTM Oil #2)to AS | |
| 18 hrs at 120° C., % Retention of: | |
| TS | 74% |
| EB | 69% |
| ESCR, HST and OR are excellent in this example. | |

### EXAMPLE 5

| | |
|---|---|
| HDPE HD6095*, (S.G. 0.960, MFI = 0.8) | 100 |
| *Original bottle grade polymer | |
| Vinyl silane and peroxide mix (Silox VS911) | 1.2 phr |
| Antioxidant and catalyst MB (added later) | 5 phr |
| HST | 17% |
| ESCR | 3000 hrs+ |

### EXAMPLE 6

| | |
|---|---|
| HDPE HD6095, (S.G. 0,960, MFI = 0.8) | 100 |
| Vinyl silane and peroxide mix (Silox VS911) | 1.4 phr |
| Antioxidant and catalyst MB (added later) | 5 phr |
| HST | 10% |
| ESCR F0 | 3800 hrs+ |

### EXAMPLE 7

| | |
|---|---|
| HDPE, scrap, melt filtered and pelletised | 100 |
| Vinyl silane and peroxide mix (Silox VS911) | 1.2 phr |
| Antioxidant and catalyst MB (added later) | 5 phr |
| HST | 37% |
| TS | 22.3 Mpa |
| EB | 251% |
| O.R. (120° C., 18 hrs), ret. of TS | 63% |
| O.R. (120° C., 18 hrs), ret. of EB | 77% |

### EXAMPLE 8

| | |
|---|---|
| HDPE milk bottle scrap, granulated and pre-dried | 87.68% |
| HDPE GF7660 powder (Qenos) | 10% |
| Vinyl silane and peroxide mix (Silox VS911) | 1.2% |
| Irgafos 168 | 0.1% |
| Process aid masterbatch | 1% |
| Calcium Stearate | 0.02% |
| Catalyst masterbatch (DOTDL based) | 5% |
| added later, prior to forming (5% to 95% of the above) | |
| HST | 33% |
| ESCR F30 at 96 hrs | |
| Not reached F40 at 302 hrs | 302 hrs++ |
| TS | 26 MPa |
| EB | 140% |
| O.R. (120° C., 18 hrs), retention of TS | 60% |
| O.R. (120° C., 18 hrs), retention of EB | 151%* |

(*denotes that the EB has increased by 51%)

### EXAMPLE 9

| Grafted HDPE bottle scrap from Example 4 | 50% (100 phr) |
|---|---|
| HD6095 original bottle grade(thermoplastic) | 47.5% (95 phr) |
| Antioxidant and catalyst masterbatch | 2.5% (5 phr) |
| HST | 47% |
| TS | 22 Mpa |
| EB | 175% |

### EXAMPLE 10

| | |
|---|---|
| HDPE milk bottle scrap, granulated and pre-dried | 64.48% (100 phr) |
| GF 7660 (HDPE) powder | 10% (15.5 phr) |
| EVA (45%) Levapren450 (co-polymer), Bayer | 23% (30.9 phr) |
| Vinyl silane and peroxide mix (Silox VS911) | 1.4% |
| Irgafos 168 | 0.1% |
| Process aid masterbatch | 1% |
| Calcium stearate | 0.02% |
| Catalyst masterbatch, (DOTDL based) | 5% |
| added later, prior to forming, | |
| (5% to 95% of the above) | |
| HST | 17% |
| ESCR F0 | 302 hrs |
| TS | 14 MPa |
| O.R. (120° C.) retention of TS | 70% |
| ESCR F0 (started recently), F0 | 302 hrs++ |

(*has potential to last longer at F0)

### EXAMPLE 11

Pre-Mix of:

| | |
|---|---|
| Granulated bottle scrap (HDPE), pre-dried | 73.8% |
| Levapren 450 (EVA copolymer) | 26.2% |
| This pre-mix was then further compounded: | |
| Pre-mixed EVA and bottle scrap (from above) | 87.78% |
| GF7660 powder (HDPE) (Qenos) | 10% |
| Vinyl silane and peroxide mix (Silox VS911) | 1.4% |
| Irgafos 168 | 0.1% |
| Process aid masterbatch | 1% |
| Catalyst masterbatch(DOTDL based) | 5% |
| (added later, prior to forming 5% to 95% of the above) | |
| HST | 33% |
| ESCR (started recently) F0 | 302 hrs++ |
| TS | 13 |
| O.R. (100° C., 18 hrs), retention | 70% |
| TS (100° C., 18 hrs), retention | 77% |
| TS (100° C., 18 hrs), retention | 114% |

### EXAMPLE 12

| | |
|---|---|
| HDPE, bottle scrap, granulated and pre-dried | 100 |
| Calcium carbonate masterbatch | 18 phr |
| (Omyacarb 2T 80%, LLDPE 20%) | |
| Vinyl silane and peroxide mix (Silox VS911) | 1.4 phr |
| Antioxidant and catalyst (DOTDL) masterbatch | 5 phr |
| (added later, prior to forming) | |
| HST | 30% |
| TS | 22 MPa |
| EB | 105% |
| Excellent HST was obtained in the presence of CaCO₃ filler. | |

### EXAMPLE 13

| | |
|---|---|
| Grafted HDPE bottle scrap from example 1 | 100 (50%) |
| HD6095 (milk bottle base resin) (Qenos) | 100 phr (50%) |
| Antioxidant and catalyst masterbatch | *% |
| (added later, prior to forming, . . . % to . . . % | |
| of the above) | |
| HST | 57% |
| ESCR F90 at | 23 hrs |
| TS | 22.7 Mpa |
| EB | 267% |
| O.R. retained, TS | 63% |
| ″ | 65% |

### EXAMPLE 14

| | |
|---|---|
| Grafted HDPE bottle scrap from Example 4 | 75% (100 phr) |
| HD6095 | 21.25% (28.3 phr) |
| Catalyst and antioxidant masterbatch | 3.75% (4.9 phr) |
| (added later, prior to forming) | |
| HST | 23% |
| ESCR F0 | 7016 hrs+ |

### EXAMPLE 15

| HDPE bottle scrap grafted from Example 4 | 50% (100 parts) |
|---|---|
| but 1.4% Silox VS911 | |
| HD6095 (HDPE bottle grade base resin) | 47.5% (95 phr) |
| and added later, separately, prior to forming: | |
| Catalyst and antioxidant masterbatch | 2.5% (5 phr) |
| HST | 37% |
| ESCR F50 | 1500 hrs |
| TS | 22.7 Mpa |
| EB | 115% |
| O.R. (18 hrs, 200° C.), ret. | |
| TS | 70% |
| EB | 136% |

### EXAMPLE 16

| | |
|---|---|
| Grafted HDPE bottle scrap from Example 7 | 75% (100 parts) |
| HD6095 (HDPE base resin, bottle grade) | 21.25% (28.3 phr) |
| Catalyst and antioxidant masterbatch | 3.75% (5 phr) |
| (added later, prior to forming) | |
| HST | 17% |
| ESCR reached F20 at 358 hrs, test continued OK, | 5024 hrs+ |
| has not reached F50 yet | |

### EXAMPLE 17

| | |
|---|---|
| Grafted HDPE bottle scrap from Example 4 | 50% (100 phr) |
| Polyolefin (metallocene type) | |
| Affinity EG8200 (Dow) | 7% (14 phr) |
| HDPE HD6095 (original bottle grade) | 40.5% (81 phr) |
| Catalyst masterbatch(added prior forming) | 2.5% (5 phr) |
| ESCR F50 | 553 hrs |

### EXAMPLE 18

| | |
|---|---|
| Grafted HDPE bottle scrap from Example 4 | 50% (100 parts) |
| HDPE GF 7660 | 47.5% (95 phr) |
| Catalyst masterbatch | 2.5% (5 phr) |
| (added later, prior to forming) | |
| ESCR F20 at 3800 hrs, tested, has not | |
| reached F50 at 5335 hrs+ | |

HDPE milk bottle scrap re-processed and not grafted or cross-linked, reached an ESCR of F50 at 3 hours only (i.e. failed) and as expected also failed the HST.

Original milk bottle grade polymer HD 6095 on injection moulded dumbell, tested under the same conditions reached an ESCR of F50 at 5 hours only.

There is very considerable and unexpectedly high improvements in the ESCR after grafting and cross-linking.

1. A method of recycling and/or upgrading olefin (co)polymer scrap and/or mixtures of olefin (co)polymer scrap and an olefin (co)polymer, said method comprising adding effective amounts of a vinyl silane and a free radical initiator to graft the vinyl silane to the olefin (co)polymer.

2. A method of upgrading olefin (co)polymer scrap and/or mixtures of olefin (co)polymer scrap and an olefin (co)polymer which fails the ESCR test as defined in ASTM No. D1693B, said method comprising adding effective amounts of a vinyl silane and a free radical initiator to graft the vinyl silane to the olefin (co)polymer.

3. A method according to claim 1, in which the olefin (co)polymer is an ethylene (co)polymer.

4. A method according to claim 3, in which the ethylene (co)polymer is polyethylene, ethylene-propylene copolymer, ethylene-propylene-diene terpolymer (EPDM), ethylene vinyl acetate copolymer (EVA) or copolymers of ethylene-alkyl acrylates.

5. A method according to claim 4, in which the polyethylene is high density polyethylene (HDPE), medium density polyethylene (MDPE), low density polyethylene (LDPE), very low density polyethylene (VLDPE), ultra low density polyethylene (ULDPE) or linear low density polyethylene (LLDPE).

6. A method according to claim 4, in which the copolymers of ethylene-alkyl acrylates are ethylene-ethyl acrylate (EEA), ethylene-butyl acrylate (EBA) and their terpolymers with maleic anhydride or mixtures thereof.

7. A method according to claim 1, in which the olefin (co)polymers are metallocene catalyst (co)polymers.

8. A method according to claim 1, in which the (co)polymers have a specific gravity (S.G.) of above about 0.936.

9. A method according to claim 8, in which the (co)polymer is HDPE.

10. A method according to claim 9, in which the HDPE has a S.G. above about 0.942.

11. A method according to claim 10, in which the HDPE has a S.G. above about 0.945.

12. A method according to claim 10, in which the HDPE has a S.G. about 0.95 to about 0.96.

13. A method according to claim 1, in which the polymer is a homopolymer.

14. A method according to claim 1, in which the (co)polymer is collected, sorted, washed, granulated, pelletised, ground and/or filtered prior to the grafting step.

15. A method according to claim 14, in which the (co)polymer is dried prior to the grafting step.

16. A method according to claim 15, in which the (co)polymer is dried to moisture levels less than about 500 ppm.

17. A method according to claim 16, in which the (co)polymer is dried to moisture levels less than about 200 ppm.

18. A method according to claim 1, in which the vinyl silane is a vinyl alkoxy silane.

19. A method according to claim 18, in which the vinyl alkoxy silane is vinyl-tris-methoxy-silane (VTMOS), vinyl-tris-methcxy-ethoxy-silane, vinyl-tris-ethoxy-silane, vinyl-methyl-dimethoxy-silane or gama-methacryl-oxypropyl-tris methoxy-silane.

20. A method according to claim 19 in which the amount of vinyl silane and free radical initiator is about 0.5 to about 2.4% by weight of the (co)polymer.

21. A method according to claim 20, in which the amount of vinyl silane and free radical initiator is about 0.8% to about 2% by weight of the (co)polymer.

22. A method according to claim 18, in which the free radical initiator is a peroxide.

23. A method according to claim 22, in which the peroxide is dialkyl peroxide or diaryl peroxide.

24. A method according to claim 23, in which the dialkyl peroxide or diaryl peroxide is dicumyl peroxide (DCP, Dicup), di-tertiary-butyl peroxide (DTEP), di-tertiary-butyl-cumyl peroxide (DTBCP), di (tert-butylperoxy-isopropyl) benzene (Luperox F) or 2,5-dimethyl-2,5-di (tert butylperoxy) hexane (Luperox 101).

25. A method according to claim 23, in which the amount of the free radical initiator is about 0.05% to about 0.3% by weight of the (co)polymer.

26. A method according to claim 25, in which the amount of the free radical initiator is about 0.08% to about 0.2% by weight of the (co)polymer.

27. A method according to claim 26, in which the amount of the free radical initiator is about 0.10% to about 0.16% by weight of the (co)polymer.

28. A method according to claim 1, in which the vinyl silane and free radical initiator are pre-mixed and added to the (co)polymer in their mixed form.

29. A method according to claim 1, in which the ratio of free radical initiator to vinyl silane is about 1:10 to about 1:15.

30. A method according to claim 1, in which the grafting step is performed at a melt temperature of from about 180° C. to about 230° C.

31. A method according to claim 30, in which the grafting step is performed at a melt temperature of from about 190° C. to about 220° C.

32. A method according to claim 31, in which the grafting step is performed at a melt temperature of from about 200° C. to about 220° C.

33. A method according to claim 1, in which one or more additives and/or fillers known in the art of polymer processing are added either before, during or after grafting of the vinyl silane.

34. A method according to claim 33, in which the additives are antioxidants, processing and/or thermal stabilisers, metal deactivators and/or copper inhibitors, UV stabilisers, blowing agents, catalysts, pigments, fillers and/or flame retardants.

35. A method according to 34, in which the amount of additive is up to about 10% by weight based on the (co)polymer and the amount of filler is up to about 50% by weight of the (co)polymer.

36. A method according to claim 1, in which either before, during or after the grafting step, other (co)polymers, their scrap and/or mixtures thereof are added to enhance the properties of the recycled and/or upgraded (co) polymer.

37. A method according to claim 36 in which the other (co)polymer is polyolefin, polypropylene, nitrile butadiene rubber, chlorinated polyethylene or chloro-sulfonated polyethylene.

38. A method according to claim 37, in which the polyolefin is ethylene vinyl acetate copolymer (EVA), ethylene ethyl acrylate copolymer (EEA), ethylene butyl acrylate copolymer (EBA), ethylene propylene rubber (EPR), ethylene-propylene copolymer (EPM), ethylene propylene-diene terpolymer (EPDM), ethylene-butylene copolymer (EBM), ethylene butylene-diene terpolymer (EBDM), very low density polyethylene (VLDPE) ultra linear low density polyethylene (ULDPE) linear low density polyethylene (LLDPE), low density polyethylene (LDPE) or medium density polyethylene (MDPE).

39. A method according to claim 38, in which the other (co)polymer is added in an amount of from about 5% to about 50% by weight of the (co)polymer.

40. A method according to claim 1, in which the recycled and/or upgraded (co)polymer is formed.

41. A method according to claim 40, in which the forming is conducted by injection moulding, blow moulding, compression moulding, extrusion calendering or conversion processes.

42. A method according to claim 41, in which the (co)polymer is cross-linked.

43. A method according to claim 42, in which the (co)polymer is cross-linked using a cross-linking catalyst.

44. A method according to claim 43, in which the cross-linking catalyst is added before, during or after the grafting step.

45. A method according to claim 42, in which the grafted and formed (co)polymer cross-links naturally in the presence of humidity without a catalyst.

46. A method according to claim 42, in which the grafted and formed (co)polymer is cross-linked in the presence of water, water vapour or steam at temperatures from about ambient up to about 115° C.

47. Olefin (co)polymer scrap and/or mixtures of olefin (co)polymer scrap and an olefin (co)polymer recycled and/or upgraded by the method defined in claim 1.

48. An article comprising at least a portion of the olefin (co)polymer scrap and/or mixtures of olefin (co)polymer scrap and an olefin (co)polymer according to claim 47.

49. An article according to claim 48, wherein the article comprises a bottle, container, box, tube, pipe, cable, profile, sheet, film or pre-form.

50. A method according to claim 20, in which the amount of vinyl silane and free radical initiator is about 0.9% to about 1.4% by weight of the (co)polymer.

51. A method according to claim 36, in which the other (co)polymer is added in an amount of from 5 to about 95% by weight of the (co)polymer.

52. A method according to claim 1, wherein the olefin (co)polymer scrap and/or mixtures of olefin (co)polymer scrap and an olefin (co)polymer fails the ESCR test as defined in ASTM No. D 1693B.

53. A method of modifying olefin polymer scrap and/or mixtures of olefin polymer scrap and an olefin polymer, said method comprising:
providing olefin polymer scrap material;
providing an effective amount of a vinyl silane and a free radical initiator; and
reacting the components to graft the vinyl silane to the olefin polymer to form a modified olefin polymer having vinyl silane grafted thereto.
